(19) United States
(12) Patent Application Publication
(10) Pub. No.: US 2021/0291872 A1
(43) Pub. Date: Sep. 23, 2021

(54) DRIVING ASSISTANCE SYSTEM, AND DRIVING ASSISTANCE PROGRAM

(71) Applicants: AISIN AW CO.,LTD., Anjo-shi (JP); TOYOTA JIDOSHA KABUSHIKI KAISHA, Toyota-shi (JP)

(72) Inventors: Yoshito KONDO, Anjo-shi (JP); Shingo KINASHI, Anjo-shi (JP); Hironobu SUGIMOTO, Nagoya-shi (JP); Akira IIJIMA, Nagoya-shi (JP); Yohei KUBO, Toyota-shi (JP)

(73) Assignees: AISIN AW CO.,LTD., Anjo-shi (JP); TOYOTA JIDOSHA KABUSHIKI KAISHA, Toyota-shi (JP)

(21) Appl. No.: 17/199,995

(22) Filed: Mar. 12, 2021

(30) Foreign Application Priority Data
Mar. 23, 2020 (JP) 2020-050575

(51) Int. Cl. B60W 60/00; B60W 50/14; G01C 21/36

(52) U.S. Cl. CPC B60W 60/0053; G01C 21/3626; B60W 50/14

(57) ABSTRACT

A driving assistance system includes: a planned travel route obtaining unit that obtains a planned travel route for a vehicle; a switching point obtaining unit that obtains a switching point from a driving assistance section to a non-assistance section on the planned travel route; and a guide control unit that displays an indication for announcing switching from the driving assistance section to the non-assistance section, from a point shifted to a near side by a predetermined section from the switching point on the planned travel route.

### INCORPORATION BY REFERENCE

This application claims the benefit of priority from Japanese Patent Application No. 2020-050575 filed on Mar. 23, 2020, the specification, drawings and abstract of which are incorporated herein by reference in their entirety.

### BACKGROUND

The present disclosure relates to a driving assistance system and a driving assistance program.

### DESCRIPTION OF THE RELATED ART

It is conventionally known that when displaying a planned travel route on a map, an autonomous driving section and a non-autonomous driving section on the planned travel route are displayed in a distinguishable manner (see, for example, Japanese Unexamined Patent Application Publication No. 2015-141478 paragraph 0056).

### SUMMARY OF THE DISCLOSURE

In the case where a vehicle moves into a non-assistance section from a driving assistance section, it is preferable for the driver to have time for preparing for driving operations before driving assistance control ends.

Aspects of the present disclosure have been made to solve the above-described problem, and an aspect of the present disclosure is to provide a technique that makes the driver more likely to be prepared in advance before the vehicle moves into a non-assistance section.

According to an aspect, there is provided a driving assistance system including: a planned travel route obtaining unit that obtains a planned travel route for a vehicle; a switching point obtaining unit that obtains a switching point from a driving assistance section to a non-assistance section on the planned travel route; and a guide control unit that announces a point shifted to a near side by a predetermined section from the switching point on the planned travel route as a point indicating switching from the driving assistance section to the non-assistance section.

According to an aspect, there is also provided a driving assistance program causing a computer to implement: a planned travel route obtaining unit that obtains a planned travel route for a vehicle; a switching point obtaining unit that obtains a switching point from a driving assistance section to a non-assistance section on the planned travel route; and a guide control unit that announces a point shifted to a near side by a predetermined section from the switching point on the planned travel route as a point indicating switching from the driving assistance section to the non-assistance section.

According to the driving assistance system and the driving assistance program, an indication for announcing switching to the non-assistance section is displayed, not from a switching point from the driving assistance section to the non-assistance section, but from the point shifted to the near side by the predetermined section from the switching point. Since the indication for announcing the switching point is displayed in this manner, it is possible to make the driver more likely to be prepared in advance before the vehicle moves into the non-assistance section from the driving assistance section.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating the configuration of a navigation system;

FIG. 2A illustrates an example of a planned travel route;

FIG. 2B illustrate a conventional display example;

FIGS. 2C to 2F illustrates display examples according to the present invention; and

FIG. 3 is a flowchart of a driving assistance section display process.

### DETAILED DESCRIPTION OF THE EMBODIMENTS

Embodiments of the present disclosure will now be described in the following order.

(1) Configuration of Navigation System

(2) Driving Assistance Section Display Process

(3) Other Embodiments

### (1) Configuration of Navigation System

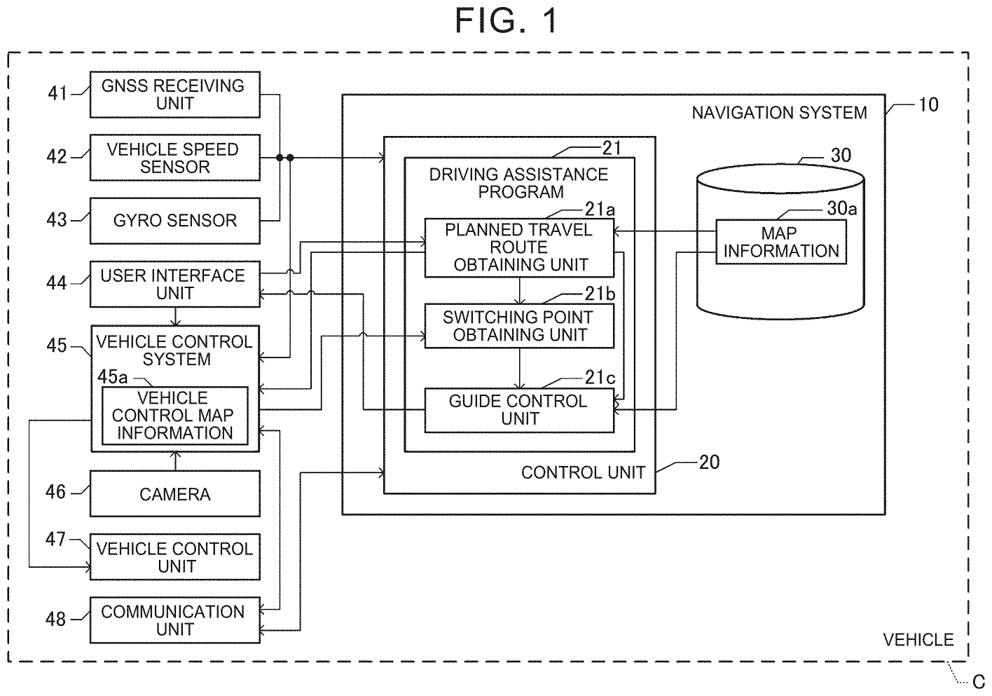

FIG. 1 is a block diagram illustrating the configuration of a navigation system 10 serving as a driving assistance system according to an embodiment of the present disclosure. The navigation system 10 is mounted on a vehicle C. The vehicle C is a vehicle that can be manually driven by a driver, and can be driven under driving assistance control by the vehicle control system 45. Regarding the assisted driving and autonomous driving, levels 0 to 5 are defined according to the extent to which the driver is involved in driving. Level 0 indicates that the driver performs all the driving operations (that is, manual driving). As for level 1 and higher levels, the higher the level is, the less the driver is involved in driving operations.

Generally, levels 1 and 2 are called assisted driving, and levels 3, 4, and 5 are called autonomous driving. However, in the following description, a road section where a predetermined level of driving assistance control can be performed is referred to a driving assistance section, and a road section where the predetermined level of driving assistance cannot be performed is referred to as a non-assistance section (a section where the necessity of involvement in driving operations is higher than the predetermined level). In this specification, the driving assistance section can be a section where autonomous driving control is performed. Further, in the following description, a non-assistance section can be a section where steering operations and acceleration/deceleration are supported by a system.

In the present embodiment, it is assumed that the predetermined level is level 3. It is also assumed that the driving assistance section is, for example, a highway. Accordingly, in the present embodiment, driving assistance control on the driving assistance section is intended to serve mainly as autonomous driving (automated driving operations) on a road section of a highway. If the driver performs a driving operation even though the vehicle is traveling on a driving assistance section, the vehicle C is controlled according to the driving operation. In the present embodiment, it is further assumed that on a non-assistance section, the subject of the driving operation is a driver (that is, for example, full manual driving is performed, or driving operations are performed with support for steering and acceleration/deceleration). It is obvious that in other embodiments, the predetermined level is not limited to level 3 and may be another level, and the driving assistance section is not limited to a highway.

Among road sections included in map information, driving assistance sections as road sections where the predetermined level of driving assistance control can be performed are determined in advance. The vehicle C can obtain information on the driving assistance sections from a server (not illustrated). Needless to say, the driving assistance sections may dynamically change with the weather and the road conditions.

The vehicle C of the present embodiment includes a GNSS receiving unit 41, a vehicle speed sensor 42, a gyro sensor 43, a user interface unit 44, a vehicle control system 45, a camera 46, a vehicle control unit 47, and a communication unit 48.

The GNSS receiving unit 41 is a device that receives a signal from a global navigation satellite system. The GNSS receiving unit 41 receives a radio wave from a navigation satellite, and outputs a signal for calculating the current position of a vehicle via an interface (not illustrated). The control unit 20 receives this signal to obtain the current position of the vehicle. The vehicle speed sensor 42 outputs a signal corresponding to the rotation speed of a wheel of the vehicle. The control unit 20 receives this signal via an interface (not illustrated) to obtain the vehicle speed. The gyro sensor 43 detects an angular acceleration of turning of the vehicle in a horizontal plane, and outputs a signal corresponding to the orientation of the vehicle. The control unit 20 receives this signal to obtain the traveling direction of the vehicle. The vehicle speed sensor 42 and the gyro sensor 43 are used for specifying a travel trajectory of the vehicle. In the present embodiment, the current position is specified based on a departure point and the travel trajectory of the vehicle, and the current position of the vehicle specified based on the departure point and the travel trajectory is corrected based on an output signal of the GNSS receiving unit 41.

The user interface unit 44 is an interface unit for receiving user's instructions and providing various information to the user, and includes a touch panel display and a speaker. That is, the user interface unit 44 includes an output unit for outputting images and audio, and an input unit for receiving user's instructions.

The communication unit 48 is a communication circuit that communicates wirelessly with servers (not illustrated). The servers with which the vehicle C communicates via the communication unit 48 include a map server. The map server is a server that manages, updates, and distributes map information 30a for the navigation system 10 and vehicle control map information 45a for the vehicle control system 45. The vehicle C communicates with the map server via the communication unit 48 so as to obtain and update the map information 30a and the vehicle control map information 45a.

The vehicle control system 45 is a computer that performs driving control on the vehicle C. The vehicle control system 45 is connected to the vehicle control unit 47. The vehicle control unit 47 includes various actuators that control steering, acceleration, and braking. A storage medium (not illustrated) of the vehicle control system 45 stores the vehicle control map information 45a. The vehicle control map information 45a is used when the vehicle control system 45 performs driving assistance control.

The vehicle control map information 45a includes link correspondence information, lane data, road marking paint data, and driving assistance availability information. The link correspondence information is information indicating a corresponding relationship between links defined in the map information 30a and road sections used in the vehicle control map information 45a. The lane data includes data representing the lane structure and the lane shape of the corresponding link. The road marking paint data includes data representing the positions where road marking paint is applied, and their meanings.

The driving assistance availability information is information indicating whether a road section is a section where the predetermined level of driving assistance control can be performed. More specifically, the driving assistance availability information is set for each of the road sections defined in the vehicle control map information 45a, and indicates a value representing whether the road section is a section where the predetermined level of driving assistance control can be performed (for example, 1 if the control can be performed, and 0 if the control cannot be performed). An end of a road section in the vehicle control map information 45a may or may not coincide with an end point (that is, a node) of a link in the map information 30a. Therefore, a start point and an end point of the driving assistance section also may or may not coincide with nodes in the map information 30a.

Upon obtaining a planned travel route from the navigation system 10, the vehicle control system 45 specifies road sections in the vehicle control map information 45a corresponding to links included in the planned travel route, based on the link correspondence information. The vehicle control system 45 reports the driving assistance availability information of each specified road section to the navigation system 10. Upon obtaining the driving assistance availability information of the road sections included in the planned travel route, a driving assistance section and a non-assistance section on the planned travel route are specified as described below.

In the case where the vehicle C travels on a driving assistance section and the driver does not perform driving operations, the vehicle control system 45 performs driving assistance control (autonomous driving control in the present embodiment) on the vehicle C, by controlling the vehicle control unit 47, based on outputs of the GNSS receiving unit 41, the vehicle speed sensor 42, the gyro sensor 43, the camera 46, and various other sensors (not illustrated), and the vehicle control map information 45a. Note that in the case where a driving operation is performed by the driver even though the vehicle C is traveling on a driving assistance section, the vehicle control system 45 controls the vehicle control unit 47 according to the driving operation by the driver.

When the vehicle C travels on a non-assistance section, the vehicle control system 45 controls the vehicle control unit 47 according to mainly driving operations by the driver, and performs control for inter-vehicle distance keeping and lane keeping according to an instruction from the driver or settings made in advance in the present embodiment. When the vehicle C travels under the autonomous driving control on a driving assistance section and reaches an end point of the driving assistance section (that is, a switching point from the driving assistance section to the following non-assistance section), the autonomous driving control ends, and the vehicle control unit 47 is controlled according to mainly driving operations by the driver.

The camera 46 is an image sensor for capturing a front view image and a rear view image of the vehicle C. The vehicle control system 45 recognizes (detects) objects present on and around the road, by performing image recognition processing on the front view image and the rear view image of the vehicle C captured by the camera 46. More specifically, the vehicle control system 45 recognizes images of objects, namely, lane lines, road marking paint, and landmark features, in the front view image and the rear view image. Then, the vehicle control system 45 obtains a position of the vehicle C on which the camera 46 is mounted, based on positions of the recognized images of the lane lines, the road marking paint, and landmark features in the captured images, and their positions in the real space. Note that the positions of the lane lines, the road marking paint, and landmark features in the real space can be obtained from the vehicle control map information 45a.

The navigation system 10 includes a control unit 20 including a CPU, a RAM, and a ROM, and a storage medium 30. The navigation system 10 can cause the control unit 20 to execute programs stored in the storage medium 30 and the ROM. The programs executed by the control unit 20 include the driving assistance program 21.

The storage medium 30 stores the map information 30a in advance. The control unit 20 can update the map information 30a, based on map information obtained by communicating with the map server (not illustrated) via the communication unit 48. The map information 30a is map data used for route search and route guidance. The map information 30a includes node data indicating the position of each node set on a road on which a vehicle travels, shape interpolation point data indicating the position of a shape interpolation point for specifying the shape of a road between nodes, link data indicating links between nodes, and feature data indicating features that are present on and around a road. In the present embodiment, a node represents a junction. The link data includes data indicating the road type, the road width, and the number of lanes. The feature data includes data indicating the name of category of facilities, and the location and shape of the facilities.

The control unit 20 can execute a navigation program (not illustrated), and can execute a driving assistance program 21 as a function of the navigation program. The driving assistance program 21 is a program that implements a function of assisting the driver, by displaying a driving assistance section and a non-assistance section on a planned travel route in a distinguishable manner such that the driver recognizes the driving assistance section and the non-assistance section. To implement this function, the driving assistance program 21 includes a planned travel route obtaining unit 21a, a switching point obtaining unit 21b, and a guide control unit 21c.

The planned travel route obtaining unit 21a is a program module for causing the control unit 20 to implement a function of obtaining a planned travel route of a vehicle. That is, with the function of the planned travel route obtaining unit 21a, the control unit 20 receives an input of a destination by the user via the input unit of the user interface unit 44, searches for a route from the current position of the vehicle to the destination based on the map information 30a, and obtains a planned travel route.

The switching point obtaining unit 21b is a program module that causes the control unit 20 to implement a function of obtaining a switching point from a driving assistance section to a non-assistance section on the planned travel route. With the function of the switching point obtaining unit 21b, the control unit 20 reports the planned travel route to the vehicle control system 45, and obtains driving assistance availability information of each road section included in the planned travel route from the vehicle control system 45. The control unit 20 obtains the positions of a start point and an end point of a driving assistance section on the planned travel route, based on the driving assistance availability information. Note that when, for example, the predetermined level of driving assistance control can be performed on a plurality of continuous road sections, the control unit 20 recognizes a section formed of the plurality of continuous road sections as a single driving assistance section. The control unit 20 recognizes the end point of the driving assistance section as a switching point from the driving assistance section to the following non-assistance section. Note that the control unit 20 recognizes a start point of the driving assistance section as a switching point from the immediately preceding non-assistance section to the driving assistance section.

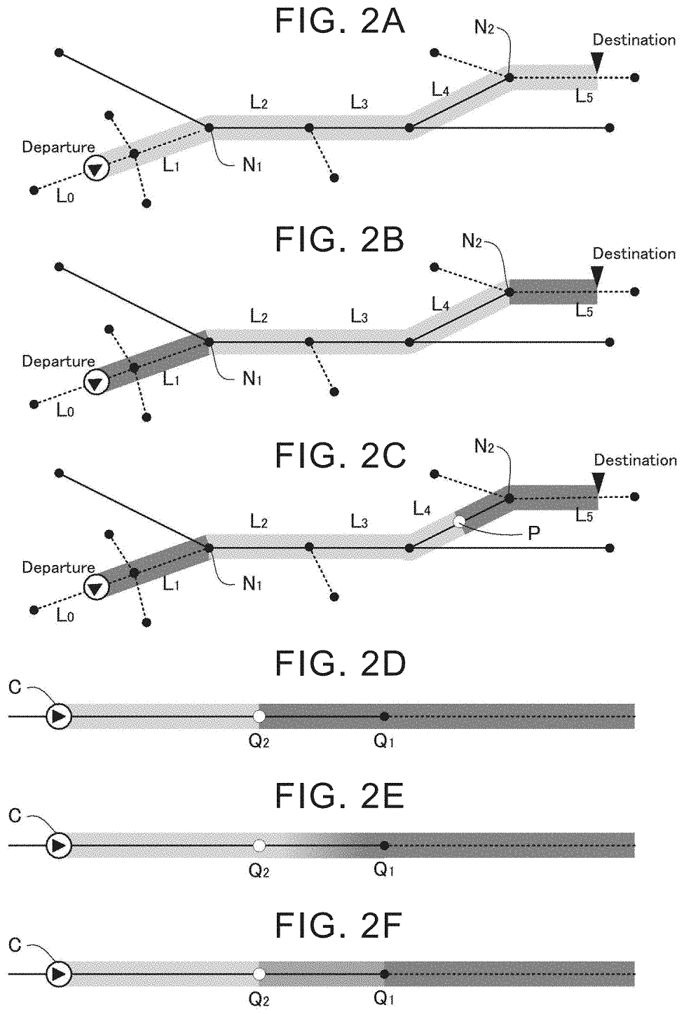

FIGS. 2A to 2C illustrate an example of a planned travel route. More specifically, FIGS. 2A to 2C illustrates a planned travel route and the connection relationship between the links therearound. In this example, a start point and an end point of a driving assistance section coincide with nodes in the map information 30a. In FIGS. 2A to 2C, a black circle represents a node, and a line segment connecting nodes represents a link. A solid line segment represents a link corresponding to a driving assistance section, and a dashed line segment represents a link corresponding to a non-assistance section. In FIGS. 2A to 2C, a bold gray line represents a planned travel route. That is, on the planned travel route illustrated in FIGS. 2A to 2C, links L₂, L₃, and L₄ are driving assistance sections, and links L₀, L₁, and L₅ are non-assistance sections. For example, it may be assumed that the links L₂ and L₃, are a main lane of a highway; the links L₀ and L₅ are general roads; and the links L₁ and L₄ are ramps. Note that in the example illustrated in FIGS. 2A to 2C, the vehicle travels on the planned travel route in the order of L₀, L₁, L₂, L₃, L₄, and L₅. The control unit 20 checks the links of the planned travel route in the order of traveling, and obtains a node N₂ that is a switching point from the driving assistance section to the non-assistance section, based on driving assistance availability information. The control unit 20 also obtains a node N₁ that is a switching point from the non-assistance section to the driving assistance section.

Conventionally, in the case of displaying a map including a planned travel route on the touch panel display of the user interface unit 44, it is common that the roads not included in the planned travel route and the roads included in the planned travel route are represented in a distinguishable manner by changing the display color or other properties. Further, it is conventionally known that a driving assistance section and a non-assistance section on the planned travel route are represented in a distinguishable manner by changing the display form. FIG. 2B illustrates an example in which a bold light gray line is displayed to be superimposed on the driving assistance section on the planned travel route, and a bold dark gray line is displayed to be superimposed on the non-assistance section on the planned travel route. Conventionally, as illustrated in FIG. 2B, a switching point from a driving assistance section to a non-assistance section is displayed on the map as it is. In the present embodiment, a driving assistance section and a non-assistance section on a planned travel route are displayed in a distinguishable manner while a point shifted to the near side by a predetermined section from a switching point from the driving assistance section to the non-assistance section is specified as an apparent switching point (an end notification point representing an end point of the driving assistance section).

The guide control unit 21c causes the control unit 20 to implement a function of displaying an indication for announcing switching from a driving assistance section to a non-assistance section, from a point shifted to the near side by the predetermined section from the switching point on the planned travel route. The control unit 20 obtains the point shifted to the near side by the predetermined section from the switching point from the driving assistance section to the non-assistance section. In the present embodiment, the control unit 20 obtains a point that the vehicle C is expected to pass N seconds (N=4 or 5, for example) before passing the switching point from the driving assistance section to the non-assistance section as the point (end notification point) shifted to the near side by the predetermined section. Therefore, the section length of the predetermined section varies with an expected vehicle speed on the driving assistance section. That is, the higher the expected vehicle speed on the driving assistance section is, the greater the section length of the predetermined section is set. The expected vehicle speed on the driving assistance section may be set based on the legal speed associated with this section and the sections preceding and following this section. The expected vehicle speed on the driving assistance section may be set based on the degree of congestion on the roads and the actual average speed of the vehicle on the driving assistance section. The legal speed is included in, for example, the link data of the map information 30a. The degree of congestion on the roads and the average speed may be obtained from a traffic information server. The traffic information server may calculate the degree of congestion and the average speed based on data collected from roadside units and probe vehicles, for example.

The control unit 20 specifies the point shifted to the near side by the predetermined section from the switching point from the driving assistance section to the non-assistance section as an apparent switching point from the driving assistance section to the non-assistance section (an end notification point of the driving assistance section). Note that in the present embodiment, the control unit 20 does not shift an apparent position of a switching point (a start point of the driving assistance section) from a non-assistance section to a driving assistance section.

A point P in FIG. 2C is a setting example of an apparent switching point from the switching point from the driving assistance section to the non-assistance section. The point P (end notification point) is a point shifted to the near side by the predetermined section from the node N₂ that is the actual switching point from the driving assistance section to the non-assistance section. The control unit 20 does not specify a section from the node N₁ to the node N₂ that is the actual driving assistance section, but specifies a section from the node N₁ to the point P as an apparent driving assistance section, and displays this section as a line in a display form representing a driving assistance section. Note that solid lines and dashed lines representing links, black circles representing nodes, and a white circle representing an end notification point are drawn to facilitate understanding, and do not have to be displayed on the map.

Further, the control unit 20 specifies a section from the point P to the node N₂ as an apparent non-assistance section, and displays this section as a line in a display form representing a non-assistance section, in the same manner as the non-assistance section after the node N₂. The control unit 20 displays a non-assistance section before the node N₁ representing the start point of the actual driving assistance section as a line in a display form representing a non-assistance section.

In this way, in the present embodiment, a driving assistance section on a planned travel route is displayed for guidance in such a manner that the driving assistance section appears to end at a point (end notification point) shifted to the near side by a predetermined section from the actual switching point from the driving assistance section to the non-assistance section. Accordingly, the driver can easily prepare in advance for the driving operations on the non-assistance section before reaching the actual switching point from the driving assistance section to the non-assistance section. Therefore, according to the present embodiment, the driver is more likely to be able to prepare for ending of the driving assistance control (autonomous driving in the present embodiment).

The guidance on a driving assistance section and a non-assistance section on a planned travel route described above may be provided when displaying the entire planned travel route (displaying the entire route) after searching for a route to the destination and before starting traveling, or may be provided when displaying a map around the current position of the vehicle C while actually traveling on the planned travel route after determining the planned travel route.

Note that in the example illustrated in FIGS. 2A to 2C, the node N₂ indicating the connection point between a ramp and a general road is the switching point from a driving assistance section to a non-assistance section. However, the switching point from a driving assistance section to a non-assistance section does not have to coincide with a node in the map information 30a. FIG. 2D illustrates an example in which a switching point from a driving assistance section to a non-assistance section is present on a main lane of a highway. In FIG. 2D, a dashed line represents a non-assistance section on a highway; a solid line represents a driving assistance section on the highway; and a black circle represents an actual switching point Q₁ from the driving assistance section to the non-assistance section. In this manner, even when the switching point Q₁ from the driving assistance section to the non-assistance section is present on the main lane of the highway, it is possible to set the length of a predetermined section based on the legal speed on the main lane of the highway, and display the route in a manner such that the non-assistance section appears to start from (the driving assistance section appears to end at) a point Q₂ shifted to the near side by the predetermined section from the point Q₁. In the example of FIG. 2D, since the predetermined section is on the highway, the expected vehicle speed may be greater compared to the case where the predetermined section is on a ramp as in the example of FIG. 2C. Therefore, in the present embodiment, the section length of the predetermined section Q₂−Q₁ may be set greater than the section length of the section P−N₂ of FIG. 2C.

### (2) Driving Assistance Section Display Process

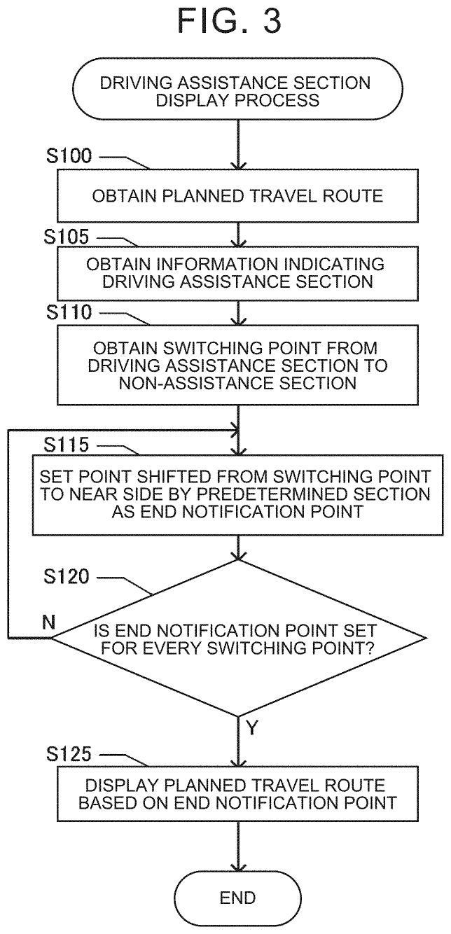

In the following, a driving assistance section display process executed by the control unit 20 will be described with reference to FIG. 3. The driving assistance section display process is a process for displaying a map including a planned travel route on the touch panel display of the user interface unit 44 and displaying a driving assistance section and a non-assistance section on the planned travel route in a distinguishable manner. It is assumed that the driving assistance section display process illustrated in FIG. 3 is executed when a passenger of the vehicle C enters a destination and requests a route search via the user interface unit 44.

When a driving assistance section display process starts, the control unit 20 obtains a planned travel route, using the function of the planned travel route obtaining unit 21a (step S100). That is, the control unit 20 obtains the current position of the vehicle C, based on output signals of the GNSS receiving unit 41, the vehicle speed sensor 42, and the gyro sensor 43. Then, the control unit 20 refers to the map information 30a to search for a route starting from the current position and reaching the destination, and obtains the route as a planned travel route.

Then, with the function of the switching point obtaining unit 21b, the control unit 20 obtains information indicating a driving assistance section (step S105). That is, the control unit 20 reports the planned travel route obtained in step S100 to the vehicle control system 45, and obtains driving assistance availability information of each road section included in the planned travel route from the vehicle control system 45.

Then, with the function of the switching point obtaining unit 21b, the control unit 20 obtains a switching point from autonomous driving to manual driving (step S110). The control unit 20 specifies, based on the information (driving assistance availability information) indicating a driving assistance section obtained in step S105, the positions of a start point and an end point of the driving assistance section included in the planned travel route. The control unit 20 obtains an end point of the driving assistance section as a switching point from the driving assistance section to a non-assistance section. Note that in the case where there are a plurality of discontinuous driving assistance sections on the planned travel route, the control unit 20 obtains end points of all the driving assistance sections (switching points to respective non-assistance sections).

Then, with the function of the guide control unit 21c, the control unit 20 sets a point (end notification point) shifted to the near side by a predetermined section from the switching point (step S115). That is, the control unit 20 obtains an expected vehicle speed on the driving assistance section having an end point at the switching point. The control unit 20 calculates a distance (a section length of the predetermined section) based on the expected vehicle speed and an allowance time of N seconds. The control unit 20 sets, as an end notification point, a point shifted to the near side by this distance on the planned travel route from the switching point.

Then, with the function of the guide control unit 21c, the control unit 20 determines whether end notification points are set for all the switching points (step S120). If not all the end notification points are set, the process returns to step S115. If in step S120, all the end notification points are determined to be set, the control unit 20 displays the planned travel route based on the end notification points, with the function of the guide control unit 21c (step S125). That is, in the present embodiment, the control unit 20 determines a scale such that the entire planned travel route fits into a map display area of the display, and draws a map of the area including the entire planned travel route on a map display area of a RAM at the above scale. The control unit 20 draws a section from the actual start point of the driving assistance section to the end notification point as a line in a display form representing a driving assistance section, so as to be superimposed on the planned travel route drawn in the RAM. The control unit 20 draws the other sections on the planned travel route as lines in a display form representing a non-assistance section. The control unit 20 displays a map on the touch panel display of the user interface unit 44, based on the data drawn on the map display area of the RAM.

Note that in the case where the planned travel route obtained in step S100 does not include a driving assistance section, the control unit 20 displays the entire planned travel route as a line in a display form representing a non-assistance section.

### (3) Other Embodiments

The embodiment described above is merely an example, and various other embodiments may be possible. For example, at least part of the planned travel route obtaining unit 21a, the switching point obtaining unit 21b, and the guide control unit 21c of the driving assistance system may be split and included in a plurality of devices. For example, part of the function of the planned travel route obtaining unit 21a may be implemented by a server. Part of the function of the switching point obtaining unit 21b and the guide control unit 21c may be implemented by the vehicle control system 45. It is obvious that part of the components of the above embodiment may be omitted, and steps of processing may be changed or omitted.

The planned travel route obtaining unit only needs to obtain a planned travel route of a vehicle, and the planned travel route only needs to be a route on which the vehicle is more likely to travel than other roads. For example, the planned travel route may be a route that allows the vehicle to travel along a road from the current position, or may be a route that connects to a destination set by the user. The planned travel route may be an optimum route searched for with a known route search method. The planned travel route may be a route set by the navigation system mounted on the vehicle, or may be a route set by a server that can communicate with the vehicle.

The switching point obtaining unit only needs to obtain a switching point from a driving assistance section to a non-assistance section on a planned travel route. Information indicating a driving assistance section may have any data structure as long as a start point and an end point of a driving assistance section and a start point and an end point of a non-assistance section can be identified. In the present embodiment, information indicating a driving assistance section is obtained by referring to the vehicle control map information 45a. However, the present disclosure is not limited thereto. The map information 30a and the vehicle control map information 45a may be integrated on the vehicle C. The information indicating a driving assistance section may be obtained from a server each time a route search is performed or route guidance is provided.

The driving assistance section only needs to be a road section where the predetermined level of driving assistance control can be performed. The non-assistance section only needs to be a road section where the predetermined level of driving assistance control cannot be performed. The driving assistance control that can be performed on the driving assistance section may be implemented in various manners. The control on the non-assistance section may also be implemented in various manners. For example, in other embodiments than the embodiment described above, the control of levels 3 and 4 may be performed on the driving assistance section, and the control of level 0, that is, full manual driving may be performed on the non-assistance section. For example, in other embodiments than the embodiment described above, control of levels 1 or higher may be performed on the driving assistance section, and control of level 0, that is, full manual driving may be performed on the non-assistance section.

In another embodiment, for example, the driving assistance control may be control for assisting in acceleration and deceleration of a vehicle, or may be control for assisting in steering. The driving assistance control may be performed based on information detected by various sensors mounted on the vehicle. The various sensors may include an image sensor, a radar, and an acoustic sensor.

The guide control unit only needs to display an indication for announcing switching from a driving assistance section to a non-assistance section, from a point shifted to the near side by a predetermined section from a switching point on a planned travel route. That is, as in the above embodiment, the guide control unit may be configured to announce the point shifted to the near side by the predetermined section from the actual switching point as an end point of the driving assistance section, or may be configured to announce the predetermined section as a transition preparation section from the driving assistance section to the non-assistance section.

That is, the guide control unit may be configured to display an indication for announcing the switching in association with the predetermined section. For example, as illustrated in FIGS. 2E and 2F, the predetermined section (the section from the point Q₂ to the point Q₁) on the actual driving assistance section, a non-predetermined section (the section on the near side of the point Q₂) on the actual driving assistance section, and the actual non-assistance section (the section after the point Q₁) may be displayed in distinguishable manner. More specifically, as illustrated in FIG. 2E, the predetermined section (the section from the point Q₂ to the point Q₁) on the actual driving assistance section may be displayed with color gradation gradually shifting from a display color representing a driving assistance section to a display color representing a non-assistance section. Alternatively, for example, as illustrated in FIG. 2F, the predetermined section (the section from the point Q₂ to the point Q₁) on the actual driving assistance section may be displayed in a neutral color between the display color representing a driving assistance section to the display color representing a non-assistance section. In this way, if the predetermined section is displayed in a distinguishable manner, it is possible to announce the predetermined section as a transition preparation section from the driving assistance section to the non-assistance section. Further, for example, if the predetermined section is displayed as illustrated in FIG. 2F, the driver can recognize the actual switching point from the driving assistance section to the non-assistance section.

Note that the guide control unit may set the section length of the predetermined section in various ways. For example, the guide control unit may set the section length of the predetermined section according to the road type of the driving assistance section. For example, in the case where the driving assistance section is a road of a type indicating that the size is a first size, the section length may be set greater than in the case where the driving assistance section is a road of another type indicating that the size is a second size (<the first size). With this configuration, on the predetermined section having a section length that is set according to the size of the driving assistance section, the driver is more likely to be prepared in advance.

Further, the guide control unit may set the section length of the predetermined section according to traffic information of the driving assistance section. The traffic information may include, for example, the degree of traffic congestion, speed limit, and lane closure. For example, in the case where the traffic information indicates that the expected vehicle speed on the driving assistance section is likely to decrease, the section length may be set less than in the case where the traffic information does not indicate so. With this configuration, on the predetermined section having a section length that is set according to the traffic information of the driving assistance section, the driver is more likely to be prepared in advance.

Further, the guide control unit may set the section length of the predetermined section such that the greater the section length of the driving assistance section is, the greater the section length of the predetermined section is. If, for example, the driving assistance section is a section where autonomous driving control of level 3 is performed, the driver basically does not have to perform driving operations on the driving assistance section. Therefore, the greater the length of the driving assistance section is, the more the driver gets used to the autonomous driving state, and the greater the delay in preparation may be (the longer it may take for the driver to get ready for performing driving operations). In view of this, the greater the section length of the driving assistance section is, the greater the predetermined section may be set. In this way, the driver is more likely to be prepared in advance according to the conditions of the driver.

Further, the guide control unit may set the section length of the predetermined section such that the higher the level of difficulty in driving operations on the non-assistance section is, the greater the section length of the predetermined section is. The level of difficulty is high in situations such as when the road is curved and when there is a great difference in expected vehicle speed between the driving assistance section and the non-assistance section. The level of difficulty is not high in situations such as when the road is straight and when there is a small difference in expected vehicle speed. In the case where the level of difficulty in driving operations on a non-assistance section following a driving assistance section is high, the section length of the driving assistance section may be set greater than in the case where the level of difficulty is not high. In this way, the driver is more likely to be prepared in advance.

The guide control unit may set the section length of the predetermined section such that the lower the driving skill level of a driver of the vehicle is, the greater the section length of the predetermined section is. In the case where the driving skill level of the driver is low, it may be desirable to spend longer time to prepare for driving operations than in the case where the driving skill level is not low. The driver with high driving skills may not need so much time. In view of this, the section length of the predetermined section may be variably set according to the driving skill level of the driver. In this manner, it is possible to give a preparation time with a length appropriate for the conditions of the driver. The driving skill level of the driver may be determined, for example, based on the total travel distance of the vehicle, or based on authentication of the driver and the travel history of the driver (such as the total travel distance, the total driving time, the driving frequency, the size of the area traveled by the vehicle, and the driving frequency on a per road type basis).

The guide control unit may set the section length of the predetermined section such that the fewer the number of times the vehicle has previously traveled on the driving assistance section and the non-assistance section is, the greater the section length of the predetermined section is. If the vehicle has previously traveled many times, the driver may be used to driving on the non-assistance section following the driving assistance section. If the vehicle has previously traveled a few times, the driver may not be used to driving on the non-assistance section. In view of this, the fewer the number of times the vehicle has previously traveled, the greater the section length of the predetermined section may be set. In this manner, it is possible to give a preparation time with a length appropriate for the conditions of the driver.

The guide control unit may be configured such that the section length of the predetermined section is set greater when weather of an area including the switching point is rough than when the weather is not rough. When the weather is rough, careful attention is likely to be required to drive on a non-assistance section. In view of this, when the weather of the area including the switching point is rough, the section length of the predetermined section may be set greater than when the weather is not rough. In this way, it is possible to give a preparation time with a length appropriate for the weather.

Further, the technique of displaying an indication for announcing switching from a driving assistance section to a non-assistance section, from a point shifted to the near side by the predetermined section from the switching point on the planned travel route as in the embodiment of the present disclosure is applicable as a program, or a method. The system, program, and method described above may be implemented as a single device, may be implemented by sharing components of the elements of the vehicle, and may be implemented in various other forms. Also, various changes may be made. For example, some elements may be implemented by software, and some other elements may be implemented by hardware. Furthermore, aspects of the present disclosure may be implemented as a storage medium for a program that controls the system. As a matter of course, the storage medium for the program may be a magnetic storage medium, a semiconductor memory, or any storage medium that may be developed in the future.

What is claimed is:

1. A driving assistance system comprising:
a planned travel route obtaining unit that obtains a planned travel route for a vehicle;
a switching point obtaining unit that obtains a switching point from a driving assistance section to a non-assistance section on the planned travel route; and
a guide control unit that announces a point shifted to a near side by a predetermined section from the switching point on the planned travel route as a point indicating switching from the driving assistance section to the non-assistance section.

2. The driving assistance system according to claim 1, wherein when displaying an entire part of the planned travel route, the guide control unit specifies the point shifted to the near side by the predetermined section from the actual switching point as an apparent switching point from the driving assistance section to the non-assistance section, and displays an apparent driving assistance section on the near side of the apparent switching point and an apparent non-assistance section ahead of the apparent switching point in a traveling direction in different display forms.

3. The driving assistance system according to claim 1, wherein the higher an expected vehicle speed on the driving assistance section is, the greater a section length of the predetermined section is.

4. The driving assistance system according to claim 1, wherein a section length of the predetermined section is set according to a road type of the driving assistance section.

5. The driving assistance system according to claim 1, wherein a section length of the predetermined section is set according to traffic information of the driving assistance section.

6. The driving assistance system according to claim 1, wherein the greater a section length of the driving assistance section is, the greater a section length of the predetermined section is.

7. The driving assistance system according to claim 1, wherein the higher a level of difficulty in driving operations on the non-assistance section is, the greater a section length of the predetermined section is.

8. The driving assistance system according to claim 1, wherein the lower a driving skill level of a driver of the vehicle is, the greater a section length of the predetermined section is.

9. The driving assistance system according to claim 1, wherein the fewer the number of times the vehicle has previously traveled on the driving assistance section and the non-assistance section is, the greater a section length of the predetermined section is.

10. The driving assistance system according to claim 1, wherein a section length of the predetermined section is greater when the weather of an area including the switching point is rough than when the weather is not rough.

11. A driving assistance program causing a computer to function as:
a planned travel route obtaining unit that obtains a planned travel route for a vehicle;
a switching point obtaining unit that obtains a switching point from a driving assistance section to a non-assistance section on the planned travel route; and
a guide control unit that announces a point shifted to a near side by a predetermined section from the switching point on the planned travel route as a point indicating switching from the driving assistance section to the non-assistance section.
